(19) United States
(12) Patent Application Publication
(10) Pub. No.: US 2021/0104235 A1
(43) Pub. Date: Apr. 8, 2021

(54) Arbitration of Natural Language Understanding Applications

(71) Applicant: Nuance Communications, Inc., Burlington, MA (US)

(72) Inventors: Paulo Vinicius Radtke, Burlington, MA (US); Daniel Edoh-Bedi, Burlington, MA (US)

(21) Appl. No.: 16/590,726

(22) Filed: Oct. 2, 2019

(51) Int. Cl. G10L 15/22; G06F 17/27; G10L 15/18; G10L 15/06

(52) U.S. Cl. CPC G10L 15/22; G06F 17/2705; G10L 2015/088; G10L 15/063; G10L 15/1822

(57) ABSTRACT

A natural language understanding (NLU) system includes an arbitrator and a NLU stage. The arbitrator processes a transcription of a query and identifies, from a set of domains, a domain corresponding to the query. Each NLU application corresponds to one or more domains. Based on this identification, the arbitrator generates a match result indicating the domain. The NLU stage includes a plurality of NLU applications, and applies the query to one or more of the NLU applications based on the match result.

### BACKGROUND

Voice-based computer-implemented assistants currently exist in many consumer smartphones, and many vehicles either are equipped with an independent voice-based assistant, or connect to the built-in voice-based assistant of the smartphone. These voice-based assistants can record a voice request of the user, process the request with natural language understanding, and provide a response, such as initiating a phone call or transcribing and sending a text message. Smartphone voice assistants can further perform Internet searches, launch applications, and launch certain tasks allowed by the voice assistant.

Natural language understanding (NLU) systems receive user speech and translate the speech directly into a query. Often, NLU systems are configured to operate on smartphones. These NLU systems can also direct such a query to a search engine on the smartphone or accessible via a wireless network connection to perform Internet searches based on the content of the query.

### SUMMARY

Example embodiments include a natural language understanding (NLU) system comprising an arbitrator and a NLU stage. The arbitrator may be configured to parse a transcription of a query, the query being a spoken utterance. The arbitrator may then identify, from a set of domains, a domain corresponding to the query, each domain of the set of domains corresponding to a respective NLU application. Based on this identification, the arbitrator may generate a match result indicating the domain. The NLU stage may include a plurality of NLU applications, and may be configured to apply the query to at least one of the plurality of NLU applications based on the match result.

The match result may include a confidence score indicating a probability that the query corresponds to the domain. The NLU stage may be further configured to process the query via the at least one of the plurality of NLU applications and output a score indicating a predicted accuracy of an NLU result. A score normalizer may be configured to process the score and output a corresponding normalized score. An embedded arbitration and NLU stage may be configured to receive the normalized score.

Further embodiments include a method of operating a NLU system. A transcription of a query may be parsed, the query being a spoken utterance. From a set of domains, a domain corresponding to the query may be identified, each domain of the set of domains corresponding to a respective NLU application. A match result indicating the domain may then be generated. The query may be applied to at least one of the plurality of NLU applications based on the match result.

Still further embodiments include a method of operating a NLU system. A set of domains available by an arbitrator may be identified, each domain of the set of domains corresponding to a respective NLU application. Training data corresponding to each of the set of domains may be located in a database, the training data including representations of example queries. The training data may then be tagged to produce tagged training data that indicates correspondence between the representations and the set of domains. The arbitrator may then be trained with the tagged training data.

A query may be transcribed to generate a transcription of the query, the query being a spoken utterance. A domain corresponding to the query may be identified via the arbitrator. The query may then be provided to the NLU application associated with the domain.

The set of domains may be a subset of a plurality of domains. The set of domains may be selected from the plurality of domains. This selection may be based on a customer configuration. A confidence score may be generated indicating a probability that the query corresponds to the domain. Tagging the training data may include, for each of the set of domains, assigning a positive or negative indicator to each of the transcriptions of example queries.

Training the arbitrator may include 1) identifying sequences of keywords in the training data, and 2) assigning a score to each of the keywords, the score indicating a degree of association between the keyword and at least one of the set of domains.

The set of domains may be updated to include a new domain corresponding to a new NLU application. The database may be updated to include new training data associated with the new domain. The new training data may be tagged to indicate whether each transcription of the new training data corresponds to each of the set of domains. The arbitrator may then be tagged with the new training data.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of a speech processing system in which example embodiments may be implemented.

FIG. 2 is a block diagram of a natural language understanding (NLU) system in an example embodiment.

FIG. 3 is a block diagram of an arbitrator in one embodiment.

FIG. 4 is a flow diagram depicting a process of configuring an arbitrator in one embodiment.

FIG. 5 is a flow diagram of a process operating a NLU system in one embodiment.

FIG. 6 is a flow diagram depicting a process of score normalization in one embodiment.

FIG. 7 is a flow diagram of a process of updating a domain in one embodiment.

### DETAILED DESCRIPTION

A description of example embodiments follows.

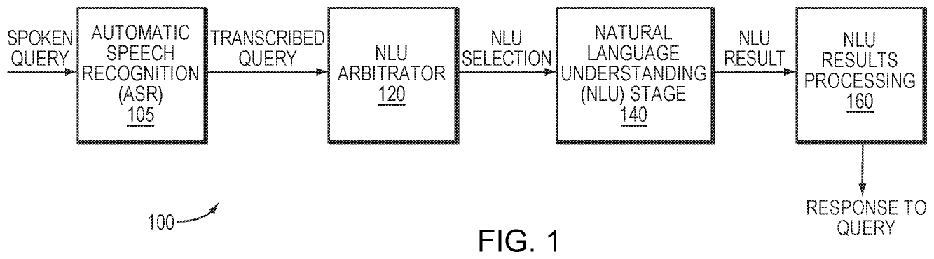

FIG. 1 is a block diagram of a speech processing system 100 in which example embodiments may be implemented. The system 100 may be implemented using one or more computing devices, such as a workstation, laptop, automobile computer, smartphone, tablet, server, and a cloud-based network. In one example, the system 100 may be distributed among one or more local computing devices and a cloud-based network that is communicatively coupled to the local computing devices.

The system 100 may include an automatic speech recognition (ASR) stage 105, which is configured to receive a spoken query (e.g., an utterance by a user at a local computing device) and generate a transcription of the query. A natural language understanding (NLU) stage 140 may include one or more NLU applications, which are configured to process the transcription and determine an appropriate response to the query. However, each of the NLU applications may be configured to process different types of queries. Conversely, some queries may be applicable to more than one NLU application, yet some of those queries may be targeted for only a subset of those NLU applications. Thus, an NLU arbitrator 120 may be configured to process the transcribed query and determine which of the NLU applications are appropriate to process the query. The NLU stage 140 may then receive an indication of the appropriate NLU applications for the query, and process the query using those selected NLU applications. A NLU results processing stage 160 may be configured to receive an output of the NLU stage 140 and take further action responsive to the query, such as communicating with the user in a dialog, retrieving and presenting data to the user, and/or executing a command corresponding to the query.

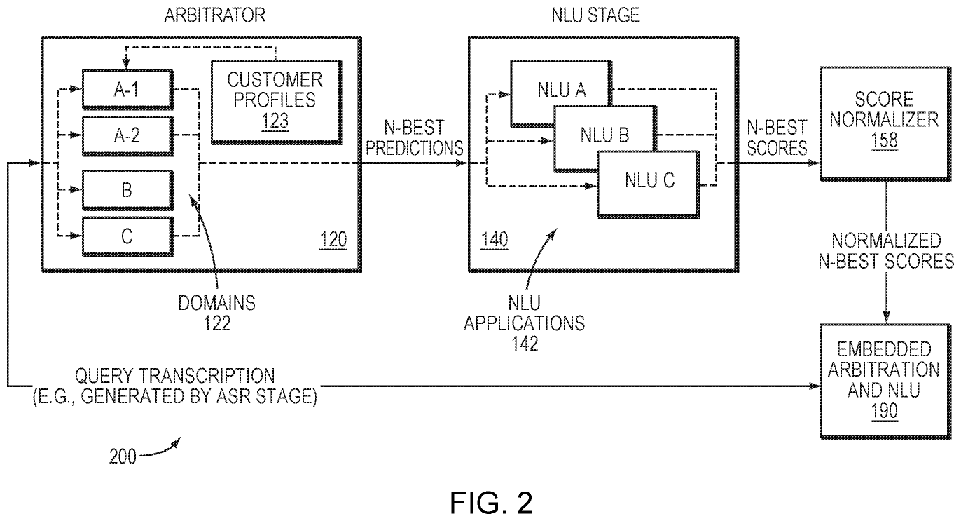

FIG. 2 is a block diagram of a natural language understanding (NLU) system 200 in an example embodiment. The system 200 may be implemented in the speech processing system 100, and may incorporate one or more features of the system 100 described above. The NLU stage 140 may be implemented wholly or partially by a cloud-based network service, and may include several different NLU applications 142 (e.g., NLU A, NLU B, NLU C). For example, the NLU applications 142 may include a reference NLU, such as an NLU that is configured by a service provider for a cloud-based NLU service. Such an NLU may be a general-purpose NLU that is adapted to handle a wide range or queries. The NLU applications 142 may also include one or more narrow-purpose NLUs, such as an NLU that is configured to handle queries for playing music and/or controlling and audio system. Other narrow-purpose NLUs may include an NLU configured to handle queries about the weather, as well as an NLU configured to handle queries for a calculator. Further, the NLU applications 142 may include one or more custom NLUs that are designed (or modified from a reference NLU) by a party such as a customer to a cloud-based NLU service. For example, the NLU system 200 may be configured for use with an automobile, and the automobile manufacturer may provide a custom NLU to enable a driver to interact with features and functions of the automobile's on-board computer system.

The support of several NLU applications 142 at the NLU stage presents a challenge to the NLU system 200, as received queries may be required to be routed to a subset of the NLU applications 142 based on customer preference and/or the query itself. Accordingly, the system 200 could be configured to route queries to one or more NLU applications 142 based on a keyword in the query. Such a solution may require manual configuration to select keywords and associate those keywords with respective NLU applications 142. Alternatively, multiple NLU applications could be merged into a single NLU application, obviating the need to route a query to a specific NLU application. However, such a merging may be disadvantageous, as it may introduce complexity to the NLU application and impede updates to the NLU application.

The arbitrator 120 provides a solution to routing queries to one or more appropriate NLU applications 142. The arbitrator 120 may possess information on a number of domains 122 (e.g., domains A-1, A-2, B and C). The domains 122 may correspond to categories that can be applied to received queries. Each of the domains 122 may be associated with one or more of the NLU applications 142. Further, multiple domains 122 may be associated with a common one of the NLU applications 142. For example, a given domain may be linked to a single one of the NLU applications 142, such as a custom NLU that is represented solely by a single domain. In another example, multiple domains may each relate to a respective category of queries (e.g., music, weather, calculations), and those multiple domains may be associated with a single NLU application that is configured to handle queries in those multiple different categories.

To determine which of the NLU applications 142 to deliver a query, the arbitrator 120 may first narrow the number of potential domains based on a profile from a profile database 123. The profile database may include multiple profiles for different users of the NLU system 200 (e.g., customers), and each profile may specify a subset of the domains 122 that are available to a given user. For example, a given profile may specify one or more reference or narrow-purpose domains as well as a custom domain specific to the user, and may exclude custom domains that are configured for different users. Once the available domains are determined, the arbitrator 120 may parse a transcription of a query, such as a transcribed query provided by an ASR stage (e.g., ASR stage 105 in FIG. 1). The arbitrator 120 may then identify, from the available domains, a domain corresponding to the query. Based on this identification, the arbitrator 120 may generate a match result (e.g., N-best predictions) indicating the domain. The match result may include a confidence score indicating a probability that the query corresponds to the domain. Alternatively, the arbitrator 120 may determine multiple domains for the query, which may be ranked or tagged based on a predicted relevance to the query.

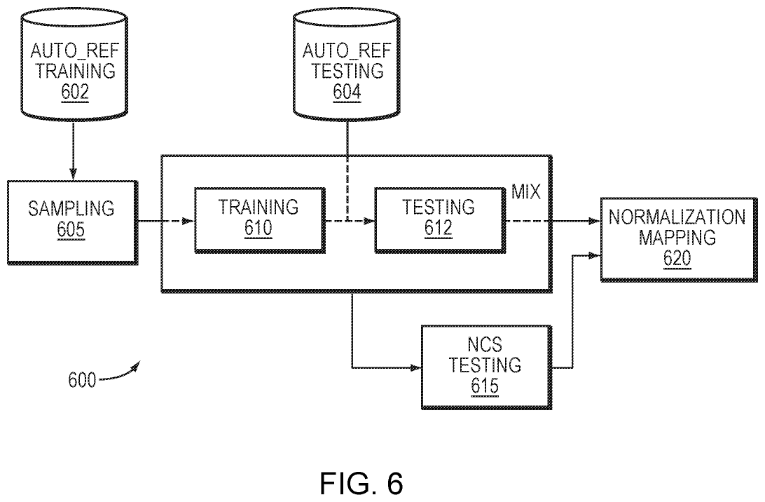

The NLU stage 140 may then apply the query to one or more of the NLU applications 142 based on the match result. For example, the NLU stage 140 may apply the query to a single one of the NLU applications 142, or to multiple NLU applications that are indicated by the match result to be most likely to match the query. The NLU stage 140 may then process the query via the matching NLU application(s), generate a result or the processing, and output a score (e.g., N-best scores) indicating a predicted accuracy of an NLU result. A score normalizer 158 may be configured to process the score and output a corresponding normalized score, as described in further detail below with reference to FIG. 6.

An embedded arbitration and NLU stage 190 may include an arbitrator and NLU stage incorporating some or all of the features of the arbitrator 120 and NLU 140, but may be distinct in its configuration and/or implementation. For example, if the arbitrator 120 and/or NLU stage 140 are implemented via a cloud-based network service, the embedded arbitration and NLU stage 190 may be implemented at one or more discrete or local computer devices, such as a device receiving the query in spoken or transcribed form. Further, the embedded arbitration and NLU stage 190 may include different NLUs from the NLU stage 140, or may have an arbitrator that is trained differently from the arbitrator 120. The embedded arbitration and NLU stage 190 may receive the normalized score, which can be used to compare performance between the arbitrator/NLU stage 120, 140 and the embedded arbitration and NLU stage 190.

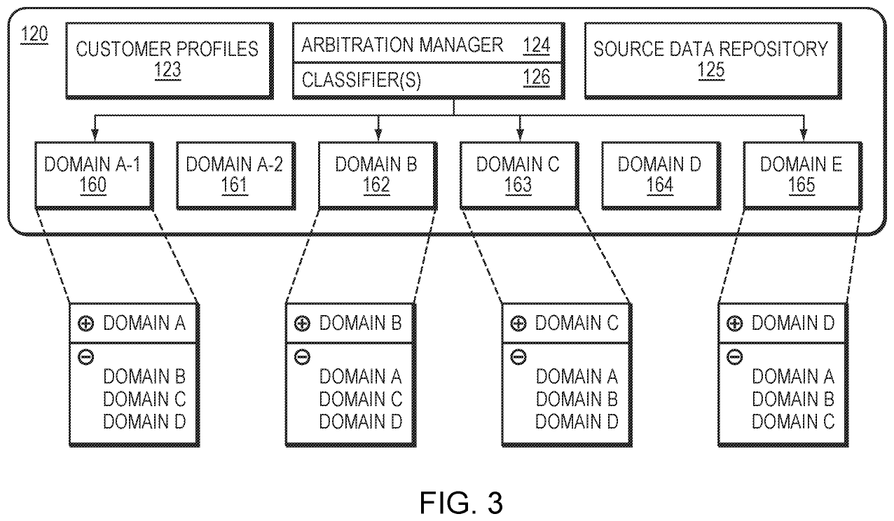

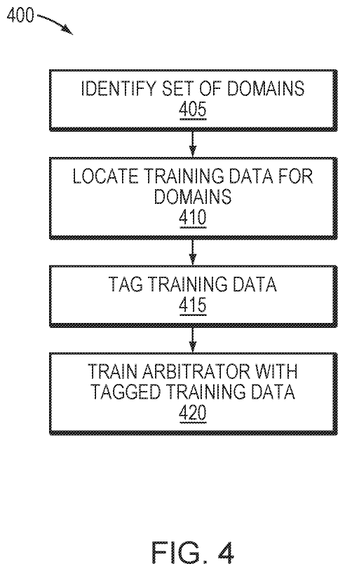

FIG. 3 is a block diagram of the arbitrator 120 in further detail. The domains 142 described above may include specific domains 160-165. For a given application, customer or query, an arbitration manager 124 may be configured to select a set of domains based on the applicable profile from the customer profiles 123 or other information as described above. An example selection is illustrated in FIG. 3, where the arbitration manager 124 is configured to select between domains 160, 162, 163 and 165, while omitting domains 161 and 164. In other applications, all of the domains 160-165 may be selected. To accurately determine an appropriate domain for a given query, one or more classifiers 126 may be trained using training data from a source data repository 125. An example training process is described below with reference to FIG. 4. Once trained, the classifiers 126 may associate each domain 160-165 with characteristics of the training data corresponding to the NLU associated with that domain. For example, as shown in inset below, the selected domains 160, 162, 163, 165, each domain is associated positively with the characteristics of the training data of an associated NLU, and is associated negatively with the characteristics of the training data of unassociated NLUs. For example, domain 160 is associated positively with the characteristics of the training data of NLU A, and is associated negatively with the characteristics of the training data of unassociated NLUs B, C and D. Further, multiple domains can be associated with the same NLU. For example, domain A-1 160 and domain A-2 161 may both be associated with NLU A, as the domains 160, 161 may be associated with different categories of queries (e.g., music and weather) that can be handled by NLU A. Thus, each domain 160-165 may be trained on a subset of training data for a given NLU, wherein the subset of training data corresponds to the category assigned to that domain. The classifiers 126 therefore can categorize a query into one or more of the domains 160-165 based on characteristics of the query.

FIG. 4 illustrates an example process 400 of configuring the arbitrator 120. With reference to FIG. 3, the arbitrator 120 may identify a set of domains available based on a customer configuration or other information as described above (405). As shown in FIG. 3, the domains selected in this example are domains 160, 162, 163 and 165. The arbitrator 120 may then locate training data corresponding to each of the set of domains 160, 162, 163, 165 may in the source data repository 125 (410). The arbitrator 120 may then tag the training data to produce tagged training data that indicates correspondence between the representations and the set of domains, and may store the tagged training data to the source data repository 125 or another data store (415). The classifiers 126 may then be trained with the tagged training data (420). Once trained, the classifiers 126 may identify a domain corresponding to a query, and the arbitrator 120 may then provide the query to the NLU stage 140 with an indication of the NLU application associated with the domain.

The training data may include representations of example queries. For example, the training data for a given domain may include example queries that, if they were received as queries to the system 200, it would be desired that they be categorized under the given domain and forwarded to the NLU(s) associated with that domain. In order to train the classifiers 126, the training data may be tagged by, for each of the set of domains, assigning a positive or negative indicator to each of the transcriptions of example queries. Such a positive or negative indicator may reflect the positive and negative associations between each domain and NLU as shown in FIG. 3. The process of training the classifiers 126 may include first identifying keywords and/or sequences of keywords in the training data. The keywords and/or sequences of keywords may be classified as such based on known characteristics of each domain (e.g., the common use of certain words or phrases in a query for a given domain), as well as an analysis of the training data to identify the words or sequences of words that are most representative of the domain (e.g., words or sequences of words that have high occurrence in one domain and low occurrence in other domains). Based on this information, the arbitrator 120 may assign a score to each of the keywords and/or sequences of keywords, the score indicating a degree of association (e.g., correspondence or likelihood of occurrence) between the keywords and/or sequences of keywords and at least one of the domains. The classifiers 126 may then be trained using this tagged and/or scored training data. For example, the classifiers 126 may be trained via a process of pattern recognition of the tagged and/or scored training data, which may be comparable to a process of training a neural network. As a result of the training, the classifiers 126 may include a statistical model based on the training data, and may be enabled to operate as a query classifier, identifying one or more appropriate domains for a received query.

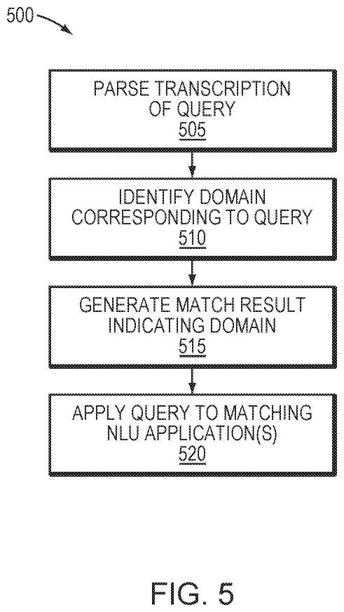

FIG. 5 is a flow diagram of a process 500 of operating the arbitrator 120. With reference to FIG. 3, following training of the classifiers 126 (e.g., as described above with reference to FIG. 4), The arbitrator 120 may parse a transcription of a query, such as a transcribed query provided by an ASR stage (e.g., ASR stage 105 in FIG. 1) (505). The arbitrator 120 may then identify, from the available domains, a domain corresponding to the query (510). Based on this identification, the arbitrator 120 may generate a match result (e.g., N-best predictions) indicating the domain (515). The match result may include a confidence score indicating a probability that the query corresponds to the domain. Alternatively, the arbitrator 120 may determine multiple domains for the query, which may be ranked or tagged based on a predicted relevance to the query.

The arbitrator 120 may then forward the query to the NLU stage 140 with an indication of the match result, enabling the NLU stage 140 to apply the query to one or more of the NLU applications 142 based on the match result (520). For example, the NLU stage 140 may apply the query to a single one of the NLU applications 142, or to multiple NLU applications that are indicated by the match result to be most likely to match the query. The NLU stage 140 may then process the query via the matching NLU application(s), generate a result or the processing, and output a score (e.g., N-best scores) indicating a predicted accuracy of an NLU result.

FIG. 6 is a flow diagram depicting a process 600 of score normalization which may be implemented by the score normalization stage 158 described above with reference to FIG. 1. The process 600 may enable confidence scores output by the NLU stage to be compared to confidence scores generated by the embedded arbitration and NLU stage 190, thereby determining relative accuracy of each NLU process.

To provide score normalization, a dataset of scores may be built by running training and testing at the arbitrator/NLU stage 120/140 and the embedded arbitration and NLU stage 190. A subset of training data 602 may be sampled (605), and an NLU model at the embedded arbitration and NLU stage 190 may be trained using the subset (610). The arbitrator/NLU stage 120/140 and the embedded arbitration and NLU stage 190 may then both be tested using a larger set of testing data 604, and the confidence scores of both may be obtained (612, 615). Use regression techniques, such as polynomial regression, a mapping between the scores from arbitrator/NLU stage 120/140 and the embedded arbitration and NLU stage 190 can be determined on a sample-to-sample basis.

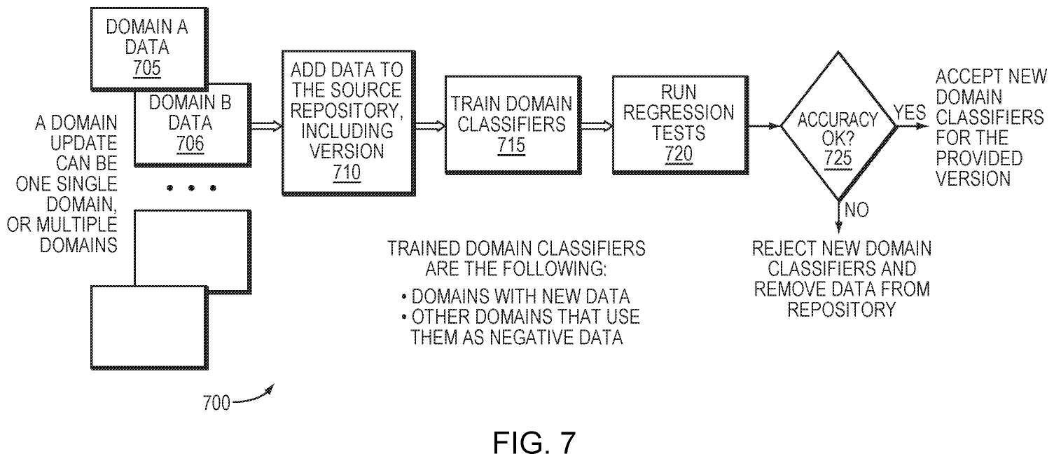

FIG. 7 is a flow diagram of a process 700 of updating the NLU system 200 to accommodate a new or updated NLU. Prior to this process 700, a user may build a custom NLU, and define a corresponding domain and training and/or testing data. With reference to FIG. 3, to begin integration of the custom NLU, the system 200 may import the associated data as domain data 705 (and/or 706) for the corresponding domain, adding the data to the source data repository 125 (710). The arbitrator 120 may then build one or more domain classifiers to map the domain data 705, as well as existing reference data, to the domains 600-605. For example, the training data may be tagged as described above. Thus, the set of domains may be updated to include a new domain corresponding to a new NLU application. The database may be updated to include new training data associated with the new domain. The new training data may be tagged to indicate whether each transcription of the new training data corresponds to each of the set of domains. The arbitrator may then be tagged with the new training data. The classifiers 126 may then undergo a training process as described above to train the classifier using the user data for the custom NLU (715).

Once training is complete, a tester module may fetch the built domain classifiers, the customer test data and the core cloud NLU test data (e.g., from the source data repository 125) (720). This operation may generate an arbitration accuracy report for each data type (e.g., user data and reference data), and may be broken down by domain and functionality (725). The report may be used to verify accuracy at several levels (e.g., overall accuracy, per domain accuracy and per functionality accuracy), ensuring that performance by the NLU(s) are meeting given quality requirements. If quality is determined to be acceptable, both arbitration and custom NLU models may be promoted by integration into the arbitrator 120 and NLU stage 140. Otherwise, the arbitration and custom NLU models may be rejected, a report may be issued with a description of the failure(s) enabling the custom NLU to be revised for future testing.

As a result of the process 700, users may have the opportunity to customize the NLU experience on their own and integrate their developed models alongside reference/core NLUs at a top level, without requiring using specific words or commands to trigger the customer developed domain. In an example embodiment, several NLUs with custom NLU models may be integrated into a single entry-point in a cloud network that provides a single n-Best NLU interpretation, ranking results from each engine according to domain likelihood and user preferences, in a seamless way that is comparable to implementing single NLU engine.

Thus, example embodiments may provide solutions to interact with user domains at the top-level NLU, without requiring special commands to switch to the custom NLU. Such embodiments may also provide means to automatically integrate the custom NLU to the core NLU engine through a streamlined promotion process wherein the NLU can be tested and integrated into an arbitrator and NLU stage automatically. In contrast, other approaches require manual integration of shadow data to perform arbitration at the user side, and manual testing before promoting models to an NLU server. Such a process is lengthy, and can take up to days to complete from building models to having them available to a user.

While example embodiments have been particularly shown and described, it will be understood by those skilled in the art that various changes in form and details may be made therein without departing from the scope of the embodiments encompassed by the appended claims.

What is claimed is:

1. A natural language understanding (NLU) system, comprising:
an arbitrator configured to:
parse a transcription of a query, the query being a spoken utterance;
identify, from a set of domains, a domain corresponding to the query, each domain of the set of domains corresponding to a respective NLU application; and
generating a match result indicating the domain; and
a NLU stage including a plurality of NLU applications, the NLU stage being configured to apply the query to at least one of the plurality of NLU applications based on the match result.

2. The system of claim 1, wherein the match result includes a confidence score indicating a probability that the query corresponds to the domain.

3. The system of claim 1, wherein the NLU stage is further configured to process the query via the at least one of the plurality of NLU applications and output a score indicating a predicted accuracy of an NLU result.

4. The system of claim 3, further comprising a score normalizer configured to process the score and output a corresponding normalized score.

5. The system of claim 4, further comprising an embedded arbitration and NLU stage configured to compare the normalized score against a score generated by the embedded arbitration and NLU stage.

6. A method of configuring a natural language understanding (NLU) system, comprising:
parsing a transcription of a query, the query being a spoken utterance;
identifying, from a set of domains, a domain corresponding to the query, each domain of the set of domains corresponding to a respective NLU application;
generating a match result indicating the domain; and
applying the query to at least one of the plurality of NLU applications based on the match result.

7. The method of claim 6, wherein the match result includes a confidence score indicating a probability that the query corresponds to the domain.

8. The method of claim 6, further comprising processing the query via the at least one of the plurality of NLU applications and output a score indicating a predicted accuracy of an NLU result.

9. The method of claim 8, further comprising processing the score and outputting a corresponding normalized score.

10. The method of claim 9, further comprising comparing the normalized score against a score generated by an embedded arbitration and NLU stage.

11. A method of operating a natural language understanding (NLU) system; comprising:
identifying a set of domains available by an arbitrator, each domain of the set of domains corresponding to a respective NLU application;
locating, in a database, training data corresponding to each of the set of domains, the training data including representations of example queries;
tagging the training data to produce tagged training data that indicates correspondence between the representations and the set of domains; and
training the arbitrator with the tagged training data.

12. The method of claim 11, further comprising:
transcribing a query to generate a transcription of the query, the query being a spoken utterance;
identifying, via the arbitrator, a domain corresponding to the query; and
providing the query to the NLU application associated with the domain.

13. The method of claim 11, wherein the set of domains is a subset of a plurality of domains.

14. The method of claim 13, further comprising selecting the set of domains from the plurality of domains.

15. The method of claim 14, wherein selecting the set of domains is based on a customer configuration.

16. The method of claim 11, further comprising generating a confidence score indicating a probability that the query corresponds to the domain.

17. The method of claim 11, wherein tagging the training data includes, for each of the set of domains, assigning a positive or negative indicator to each of the example queries.

18. The method of claim 11, wherein training the arbitrator includes:
identifying sequences of keywords in the training data; and
assigning a score to each of the keywords, the score indicating a degree of association between the keyword and at least one of the set of domains.

19. The method of claim 11, further comprising:
updating the set of domains to include a new domain corresponding to a new NLU application;
updating the database to include new training data associated with the new domain;
tagging the new training data to indicate whether each transcription of the new training data corresponds to each of the set of domains; and
training the arbitrator with the new training data.

20. A computer-readable medium storing instructions that, when executed by a computer, cause the computer to:
parse a transcription of a query, the query being a spoken utterance;
identify, from a set of domains, a domain corresponding to the query, each domain of the set of domains corresponding to a respective NLU application;
generate a match result indicating the domain; and
apply the query to at least one of the plurality of NLU applications based on the match result.
